(19) United States
(12) Patent Application Publication
(10) Pub. No.: US 2007/0299715 A1
(43) Pub. Date: Dec. 27, 2007

(54) Method and system for receiving and accessing feedback information concerning customers

(76) Inventor: George J. Brucato, Las Vegas, NV (US)

Correspondence Address: WEISS & MOY PC, 4204 NORTH BROWN AVENUE, SCOTTSDALE, AZ, 85251, US

(21) Appl. No.: 11/473,762

(22) Filed: Jun. 22, 2006

(51) Int. Cl. G06F 17/30

(52) U.S. Cl. 705/10

(57) ABSTRACT

A method and system for receiving feedback information concerning customers. Business users are permitted to provide information concerning customer infractions to a web-site maintained on a server. In one embodiment, that information is utilized to determine a score for the particular customer. Information concerning a customer's score may be accessed by other business users and, in one embodiment, by customers as well.

### FIELD OF THE INVENTION

The present invention relates generally to feedback methods and systems and, more particularly, to a system and method for receiving and accessing feedback information concerning customers.

### BACKGROUND OF THE INVENTION

It is a fundamental concept in business that obtaining proper customer feedback is important to a business's proper development and growth. Customer feedback can help a business identify areas that need improvement, whether with respect to product quality, service efficiency, or the like. Conversely, it can also help a business identify things that it is doing well and that are important to its customers, so that a business can avoid making changes that might alienate its customers.

However, from the point of view of the business, there is also concern regarding the types of customers with whom it does business. There are numerous ways in which a customer can treat a business unfairly, costing the business time and/or resources to address such conduct. For example, a customer can bounce a check, stop payment on a check without valid cause, filing a regulatory complaint or lawsuit, and so on. There are customers who engage in such activity out of a conscious desire to either receive value for which no payment is made, or to at least unfairly improve the terms of the bargain to the detriment of the business. There are also customers who engage in such activity because they have unreasonable expectations, and thus may be difficult to satisfy.

A need exists for business to be able to provide feedback regarding problem customers, and for other businesses to be able to search such feedback to be able to determine if a current or potential customer may have a poor track record. Preferably, such feedback should be provided in an objective manner, and should re reducible to a numerical or similar score.

The present invention addresses these needs and provides other, related, advantages.

### SUMMARY OF THE INVENTION

In accordance with an embodiment of the present invention, a method for receiving and accessing feedback information concerning customers is disclosed. The method comprises: permitting inputting by a first business user of information regarding infractions by a first customer; computing a customer score for the first customer based on the infractions; and permitting accessing by a second business user of the customer score for the first customer.

In accordance with another embodiment of the present invention, a method for receiving and accessing feedback information concerning customers is disclosed. The method comprises: permitting inputting by a first business user of information regarding infractions by a first customer; wherein the infractions include some that are general to a plurality of industries and some that are specific to a particular industry; computing a customer score for the first customer based on the infractions, including: assigning to the first customer an initial score; subtracting from the initial score points associated with the infractions; and computing a new customer score for the first customer; and permitting accessing by a second business user of the customer score for the first customer.

In accordance with a further embodiment of the present invention, a customer feedback receipt and access system is disclosed. The system comprises, in combination: an interface for permitting provision of infraction information by a plurality of business users concerning a plurality of customers and for permitting restricted access to the infraction information by the plurality of business users; and a database component in communication with the interface for enabling confidential storage of the infraction information.

### BRIEF DESCRIPTION OF THE DRAWINGS

FIG. 1 is a block diagram, illustrating a system consistent with an embodiment of the present invention.

FIG. 2 is an illustration of a home page that may be utilized with a system and method consistent with an embodiment of the present invention.

FIG. 3 is an illustration of a registration page that may be utilized with a system and method consistent with an embodiment of the present invention.

FIG. 4 is an illustration of a customer information submission page that may be utilized with a system and method consistent with an embodiment of the present invention.

FIG. 5 is an illustration of an infractions page that may be utilized with a system and method consistent with an embodiment of the present invention.

FIG. 6 is an illustration of a database search page that may be utilized with a system and method consistent with an embodiment of the present invention.

FIG. 7 is an illustration of a dispute form that may be utilized with a system and method consistent with an embodiment of the present invention.

FIG. 8 is a flow diagram, illustrating steps performed in a method consistent with an embodiment of the present invention.

### DETAILED DESCRIPTION OF THE PREFERRED EMBODIMENTS

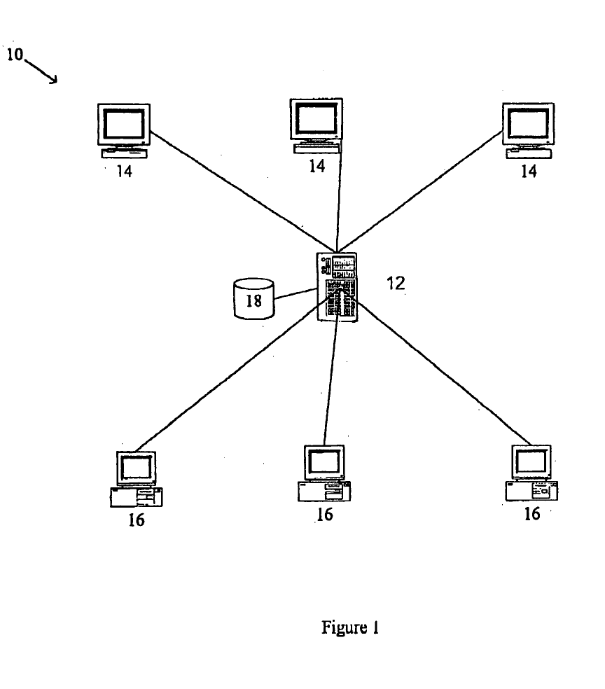

Referring briefly to FIG. 1, architecture of a system 10 consistent with an embodiment of the present invention is shown. A customer information server 12 is in communication over a network and interfaces with a plurality of business users 14 and with a plurality of customers 16. The customer information server 12 maintains a database 18 for rating information provided by business users 14 regarding customers 16. A web-site, having functionality as herein described, may be hosted at the customer information server 12.

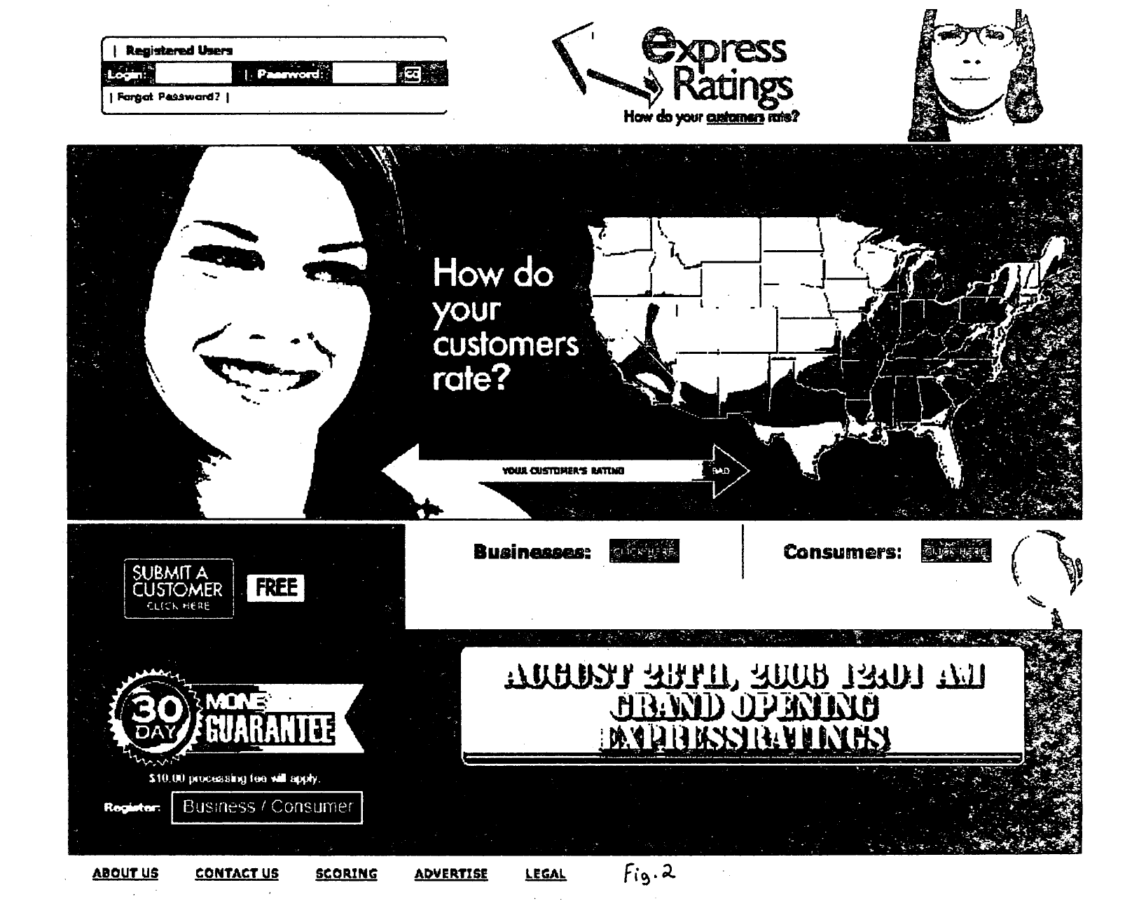

The functionality of a web-site in accordance with embodiments of the present invention will now be described. Referring firsts to FIG. 2, in one embodiment, business users and customers initially access a home page. At the home page, registered users may log in by entering login information. Users who have not registered may obtain access to a registration page for purposes of registration. It is preferable to require registration as prerequisite to performing a database search as herein described, but to not require registration in order for a business user to submit information concerning a customer, as described below. In one embodiment, registration is available to both business users and customers.

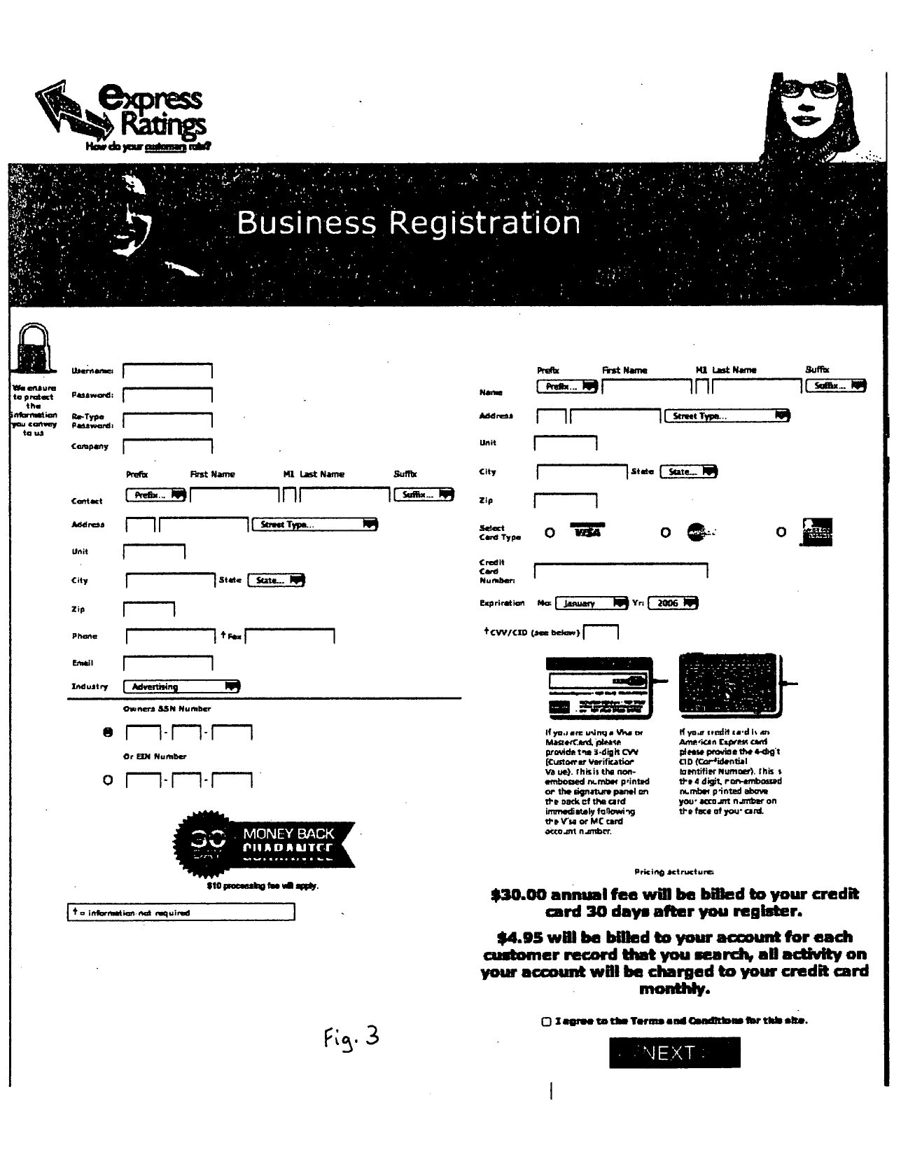

Referring now to FIG. 3, registration of a business user is described. In one embodiment, payment is required in order to permit registration by a business user. Payment may be in the form of a single fee that would permit unlimited database searching during a particular period of time, such as a year or a month. Payment may, alternatively or in combination, be in the form of a fee that is charged per customer record accessed. With respect to customer users, payment is preferably on a per record basis, though a payment permitting periodic access may also or alternatively be utilized.

It is preferable to require from registrants the provision of sufficient identifying to be able to reasonably assure that the registrant is the actual business user or customer that it purports to be. In addition to name, address and contact information, it may additionally be desired to request provision of a business owner social security number or a business taxpayer ID number, for a business registration, or a personal social security number for a customer registrant.

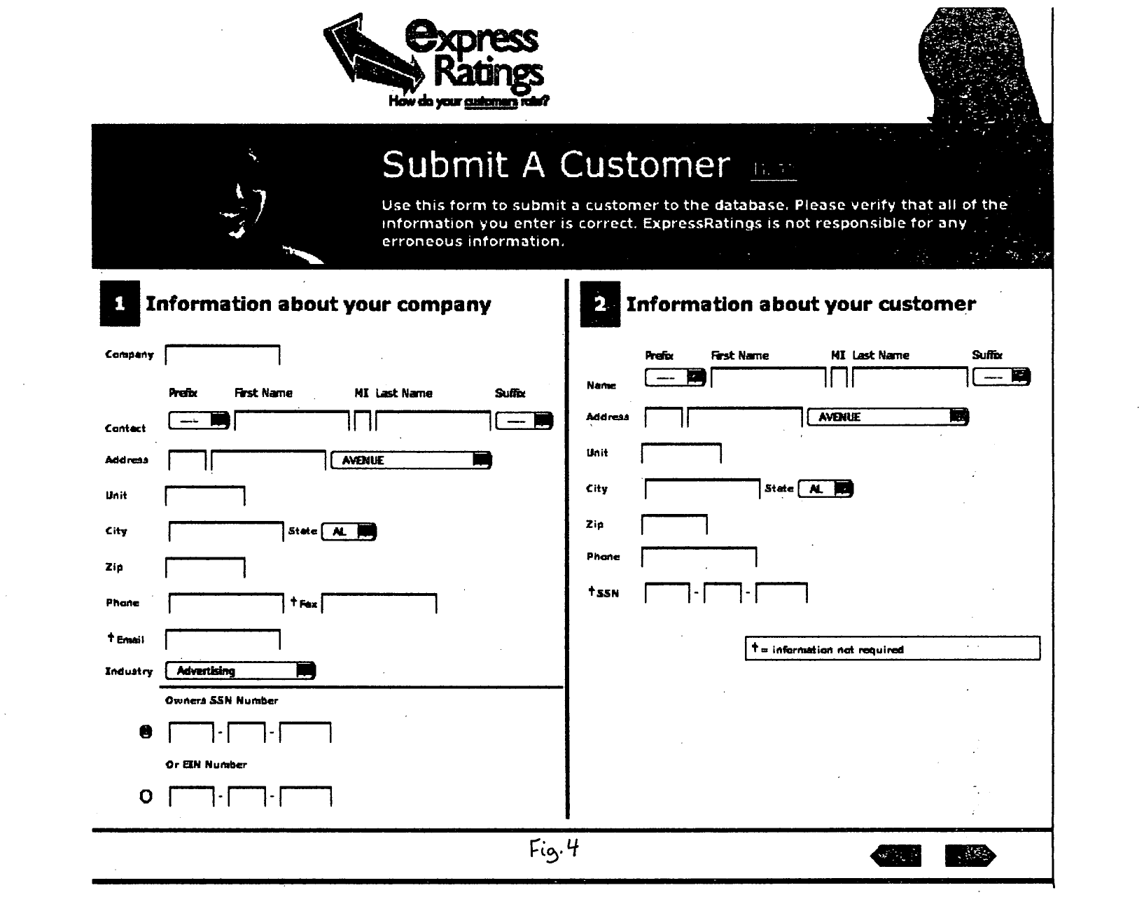

Referring now to FIG. 4, the process by which a business user may provide information regarding a customer is described. (As noted above, it is preferable to not require registration in order for a business user to be able to provide customer information, though registration may be made a requirement if desired.) FIG. 4 provides an example of a page on the web-site where initial information may be provided by a business user to submit a customer for entry into the database is disclosed. In submitting a customer, the business user should provide sufficient identifying information to be able to distinguish the customer from another person who may have the same or similar name. Such information may include address, phone number, and the customer's social security number.

Still referring to FIG. 4, whether at this page or during the registration process (see FIG. 3), it is preferable to elicit identifying information from the business user that is making the submission of a customer name. Where a business user is permitted to input customer information without first registering, such information may not have been otherwise provided by the business user previously. That information may include identification of an industry to which the business user belongs. As discussed in more detail below, identification of the business user's industry may facilitate, in one embodiment, a more specialized disclosure of information regarding a customer.

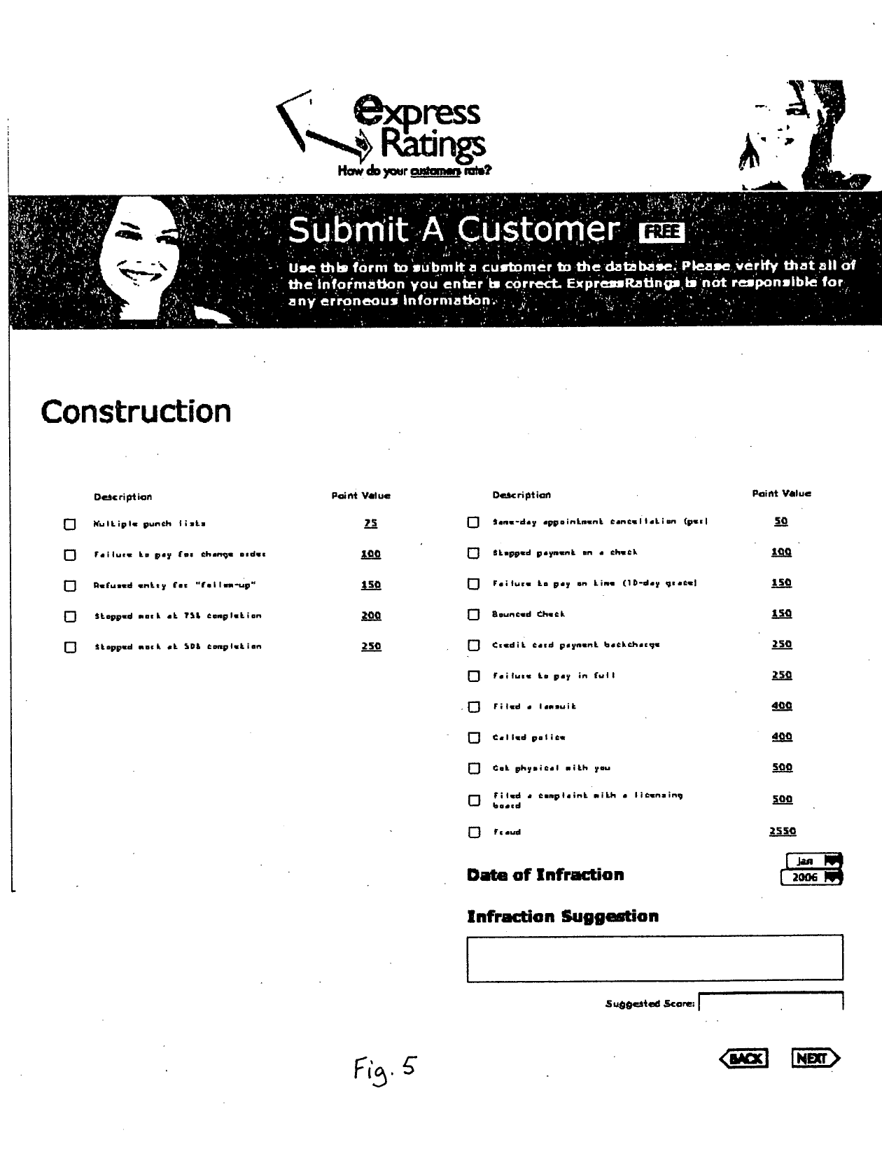

Referring now to FIG. 5, following submission of a customer, a business user may then be prompted to provide information regarding negative actions/infractions by the customer. In this embodiment, the information is provided by clicking on boxes corresponding to particular customer actions—including for example “stopped payment on a check” and “filed a lawsuit.” As noted earlier, it may be desired to elicit information from the business user regarding that user's industry. In one embodiment, the possible infractions may include ones that are specific to a particular industry.

As shown in FIG. 5, the selections on the right side would be common to multiple industries—e.g., stopping payment on a check, filing a lawsuit, not paying timely, etc. The selections on the left side may be ones that are specific to a certain industry. In the example shown in FIG. 5, the industry is construction, and the possible entries are more or less specific to the construction industry (e.g., multiple punch lists, kept materials and equipment). In addition, it may be desired to provide business users with an ability to propose new industry-specific categories for inclusion.

As indicated in FIG. 5, in one embodiment, a numerical value is assigned to each possible customer infractions. In one embodiment, each customer is assigned an initial, default score—e.g., 3,500 points. That score is then reduced by each additional infraction that is duly reported, based on the value of that infraction. Thus, stopping payment on a check may reduce a customer's score by 100 points, down to 3,400. An important advantage of a point-based system as herein described is that it provides a relatively objective scoring system, as opposed to a comments type of system that is far more subjective in nature.

In one embodiment, individual infractions last for a prescribed period of time, after which the deducted points are added back to the customer's score. In one embodiment, that period of time is five years.

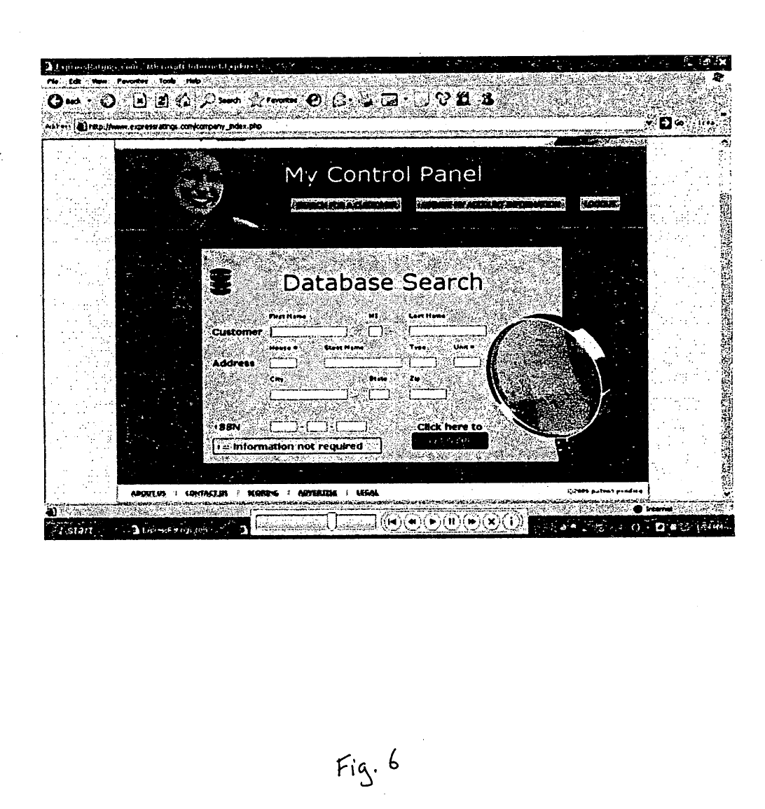

Referring now to FIG. 6, a registered business user may conduct a database search, to determine if a particular customer has been submitted to the database and, if so, whether that customer has a score. The information provided in response to a database inquiry may include the customer's identifying information, to confirm customer identity. It may additionally include the customer's score. Further, it may be desired to provide business users with the ability to access details regarding submitted infractions, including an identity of listed infractions, dates of those infractions, and/or the identity of the business user(s) who has submitted such infractions.

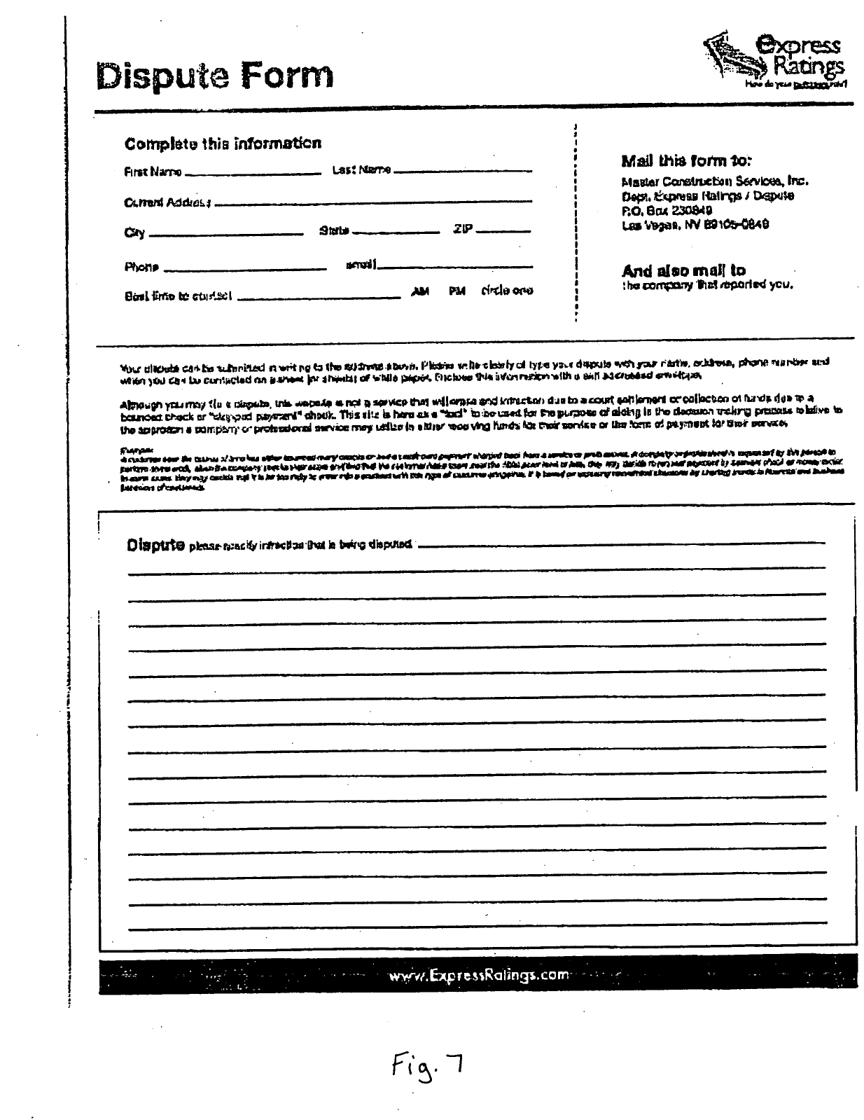

As noted above, in one embodiment, customers may also register to access the web-site. Primarily, the purpose of such registration would likely be to permit a customer to access his or her own information—to check on the customer's own score, submitted infractions, etc. It may also be desired to provide customers with the ability to dispute information contained in a submission regarding the customer by, for example, completing a dispute form, as illustrated in FIG. 7.

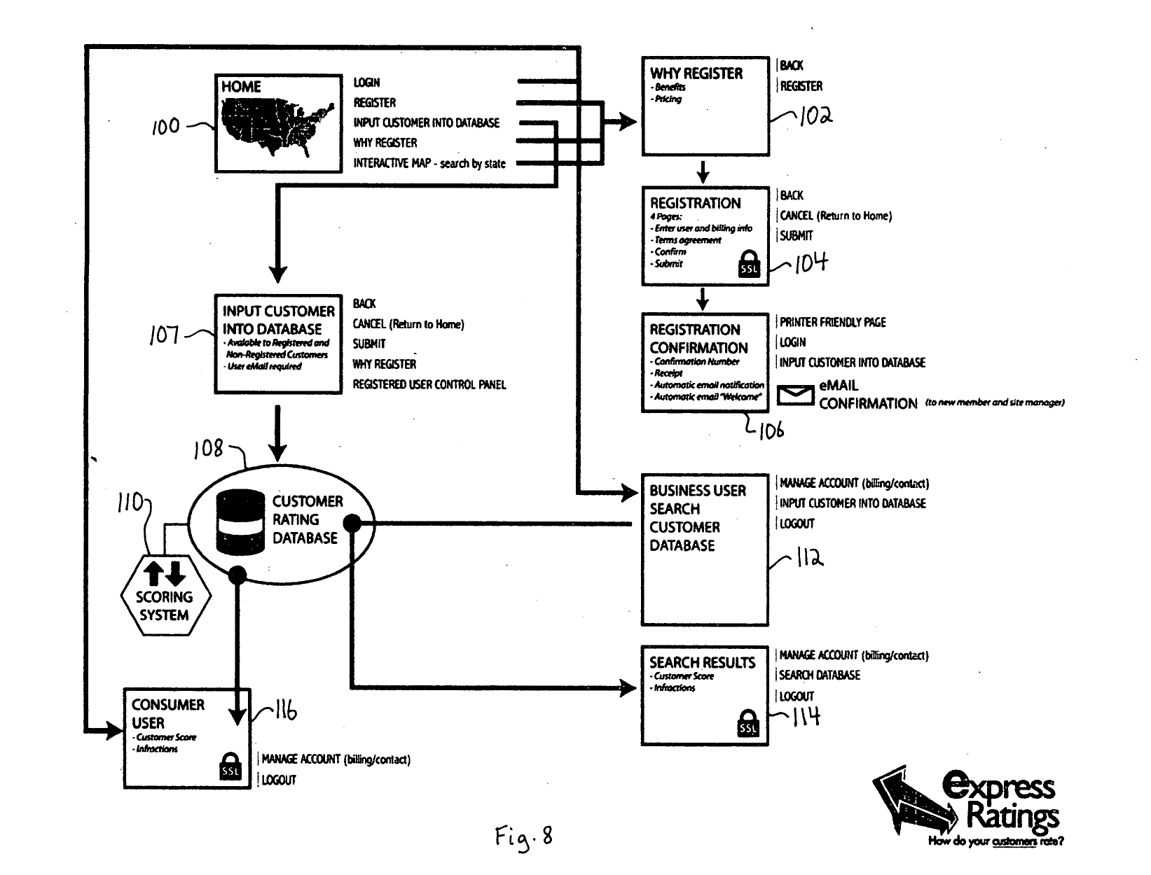

Referring now to FIG. 8, steps in a method consistent with an embodiment of the present invention are shown and described. There are a series of method steps that relate to the registration of a business user, the submission to the database of information by a business user concerning a customer, the searching of the database of customer information, and the accessing of the database by a customer. Each will be described in turn.

At step 100, a business user contacts a home page of a web-site maintained on server 12. The home page may prompt business users who have not previously registered to do so, and may provide means for a business user who has previously registered to proceed with logging in to the web-site. For business users who have not previously registered, the web-site may explain benefits of registration. In one embodiment, registration is required in order for a business user to be permitted to provide customer feedback.

Where registration is required and/or is provided as an option, the process may begin by a business user clicking on an appropriate button or icon or the like at the home page. The business user may then, at step 102, proceed to a first registration page. The first registration page may provide the business user with initial information regarding the registration process. In the event that business users are to be required to provide consideration in order to become registered, information may also be provided regarding pricing, and payment information may be elicited.

The registration process may continue at step 104 with a series of pages regarding business user information, billing information, and agreement terms governing the relationship between an operator of the web-site and the business user. During the process, the business user may be asked to confirm inputted information and/or purchase options. At the conclusion of the registration process, the business user may be asked to submit the registration.

At step 106, the business user may be provided with confirmation of registration. This may include the provision to the business user of a confirmation number or other item of unique identifying information, a receipt, the sending of a registration confirming email to an email address provided by the business user, and the sending of a welcome email to the business user. (It should be noted that the registration confirmation and welcome messages may be combined in a single email, or may be the subject of more than two email messages.) Thereafter, the business user may be added to the database 18.

The registered business user may then be permitted to input feedback information concerning a customer at step 107. As noted above, this information may be elicited by asking the business user to select certain customer infractions which the customer has committed. That information is added to database 18 at step 108, and a score is generated at step 110.

A business user who desires to search the database 18 for infraction information regarding a particular customer may do so at step 112. The results of the search may be provided at step 114. As shown in FIG. 8, at step 116, an authorized customer may be permitted to search the database 18 for information regarding a customer's user's infraction information.

While the invention has been particularly shown and described with reference to the preferred embodiments thereof, it will be understood by those skilled in the art that the foregoing and other changes in form and details may be made therein without departing from the spirit and scope of the invention.

I claim:

1. A method for receiving and accessing feedback information concerning customers comprising:
permitting inputting by a first business user of information regarding infractions by a first customer;
computing a customer score for the first customer based on the infractions; and
permitting accessing by a second business user of the customer score for the first customer.

2. The method of claim 1 wherein the infractions are general to a plurality of industries.

3. The method of claim 2 wherein the infractions include at least one of a bounced check, stopped payment on a check, a credit card charge back, a late payment, an incomplete contract, a complaint to a licensing body, and a lawsuit,

4. The method of claim 1 wherein the infractions are specific to a particular industry.

5. The method of claim 4 wherein the industry is construction and the infractions include at least one of barring access to property and keeping equipment.

6. The method of claim 1 wherein the infractions include some that are general to a plurality of industries and some that are specific to a particular industry.

7. The method of claim 1 wherein the step of computing a customer score for the first customer based on the infractions comprises:
assigning to the first customer an initial score;
subtracting from the initial score points associated with the infractions; and
computing a new customer score for the first customer.

8. The method of claim 7 further comprising adding points associated with at least one of the infractions back to the new customer score after a period of time from the inputting by the first business user of information regarding infractions by the first customer.

9. The method of claim 8 wherein the period of time is five years.

10. The method of claim 1 further comprising facilitating registration by the first business user.

11. The method of claim 10 wherein payment is required as a condition of completion of the registration.

12. The method of claim 11 wherein the payment permits access to customer scores for a period of time.

13. The method of claim 12 wherein the period of time is one year.

14. The method of claim 1, further comprising receiving payment from the second business user to receive the customer score for the first customer.

15. The method of claim 14 wherein the payment permits access to customer scores for a period of time.

16. The method of claim 14 wherein the payment permits access to a single customer score.

17. A method for receiving and accessing feedback information concerning customers comprising:
permitting inputting by a first business user of information regarding infractions by a first customer;
wherein the infractions include some that are general to a plurality of industries and some that are specific to a particular industry;
computing a customer score for the first customer based on the infractions, including:
assigning to the first customer an initial score;
subtracting from the initial score points associated with the infractions; and
computing a new customer score for the first customer; and
permitting accessing by a second business user of the customer score for the first customer.

18. The method of claim 17 further comprising adding points associated with at least one of the infractions back to the new customer score after a period of time from the inputting by the first business user of information regarding infractions by the first customer.

19. The method of claim 17, further comprising receiving payment from the second business user to receive the customer score for the first customer.

20. A customer feedback receipt and access system comprising, in combination:
an interface for permitting provision of infraction information by a plurality of business users concerning a plurality of customers and for permitting restricted access to the infraction information by the plurality of business users; and
a database component in communication with the interface for enabling confidential storage of the infraction information.
